(19) United States
(12) Patent Application Publication
(10) Pub. No.: US 2017/0098452 A1
(43) Pub. Date: Apr. 6, 2017

(54) METHOD AND SYSTEM FOR AUDIO PROCESSING OF DIALOG, MUSIC, EFFECT AND HEIGHT OBJECTS

(71) Applicant: DTS, Inc., Calabasas, CA (US)

(72) Inventors: James Tracey, San Diego, CA (US); Daekyoung Noh, Newport Beach, CA (US); Douglas Morton, Vancouver, WA (US); Themis Katsianos, Highland, CA (US)

(73) Assignee: DTS, Inc., Calabasas, CA (US)

(21) Appl. No.: 14/874,095

(22) Filed: Oct. 2, 2015

(51) Int. Cl. G10L 19/16; G10L 19/26; G10L 19/22

(52) U.S. Cl. CPC G10L 19/167; G10L 19/22; G10L 19/26

(57) ABSTRACT

Various exemplary embodiments relate to a method and apparatus for processing object-based audio signals to influence the reproduction of the audio signals. The apparatus may include an object-based audio decoder and an object post-processor. The apparatus is configured to receive an input audio stream comprising encoded dialog, music, effect, and height objects, decode from the input audio stream the dialog, music, and effect objects, process the dialog, music, and effect (DME) objects in separated signal paths; and mix the processed DME objects to produce an output audio signal for individual and customized rendering of the dynamic objects.

### BACKGROUND

Conventional audio content is input/output channel based. A number of audio objects are mixed into 2ch, 5.1ch, or 7.1ch in production. On reproduction side, audio post-processing is applied to the mixed channel-based signal to produce better audio experience on rendering devices. It is often difficult for a reproduction device to provide efficient processing and produce intended effect as it does not know what kind of audio objects are mixed in the channel-based audio signal. For example, spatial effects, such as stereo widening and virtual surround, can lower the energy in the center channel where most of dialog content is placed. Such effects may also degrade the clarity of dialog. As another example, linear phase processing is preferred for music signals, whereas EFX sound effects may require non-linear phase changes in order to create a 3D soundfield and diffused environmental sound.

Existing and currently in development object-based audio coding methods are focused on object rendering in 3D space, isolating objects, and/or interactive audio. Examples of object-based audio coding include Mpeg Spatial Audio Object Coding, DTS UHD and Dolby Atmos. These methods are not specifically designed for solving the abovementioned post-processing problems with the mixed channel audio, because in most cases, the object-based audio signals are downmixed into channels before they are processed and reproduced—the discrete audio objects become the same mixed signal as conventional audio content, forgoing the benefits of the object-based audio on the reproduction side.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method for processing an object-based audio signal, the method comprising: receiving an input audio stream comprising encoded dynamic objects including dialog, music, and effect (DME) objects, each dynamic object comprising object attributes including rendering parameters for the corresponding object; decoding from the input audio stream the dynamic objects including dialog, music, and effect objects; processing, in a first separate signal path, the decoded dialog objects based at least in part on the rendering parameters included in the dialog object attributes; processing, in a second separate signal path, the decoded music objects based at least in part on the rendering parameters included in the music object attributes; processing, in a third separate signal path, the decoded effect objects based at least in part on the rendering parameters included in the effect object attributes; and mixing the processed DME objects to produce an output audio signal for individual and customized rendering of the dynamic objects.

In some embodiments, processing separately the decoded dialog, music, and effect objects is based in part on user interaction configurations. In some embodiments, processing separately the decoded dialog, music, and effect objects comprises applying dynamic range compression and leveling. In some embodiments, processing the dialog objects comprises applying dialog enhancement to the dialog objects; processing the music objects comprises applying virtualization and surround enhancement to the music objects; and processing the effect objects comprises applying three-dimensional, virtualization, decorrelation and diffusion effects. In some embodiments, the method further comprises decoding height attributes from the input audio stream; and applying height virtualization based at least in part on rendering parameters included in the decoded height attributes. In one embodiment, the height attributes are extracted from spatial positions included in the dialog, music, and effect objects. Alternatively, the height attributes are included in height objects from the input audio stream.

Various exemplary embodiments further relate to an audio apparatus for processing an object-based audio signal, the audio apparatus comprising an object-based audio decoder configured for receiving an input audio stream comprising encoded dynamic objects including dialog, music, and effect (DME) objects, each dynamic object comprising object attributes including rendering parameters for the corresponding object; and decoding from the input audio stream the dynamic objects including dialog, music, and effect objects; an object post-processor configured for processing, in a first separate signal path, the decoded dialog objects based at least in part on the rendering parameters included in the dialog object attributes; processing, in a second separate signal path, the decoded music objects based at least in part on the rendering parameters included in the music object attributes; and processing, in a third separate signal path, the decoded effect objects based at least in part on the rendering parameters included in the effect object attributes; and a mixer configured for mixing the processed DME objects to produce an output audio signal for individual and customized rendering of the dynamic objects.

In some embodiments, processing separately the decoded dialog, music, and effect objects is based in part on user interaction configurations. In some embodiments, processing separately the decoded dialog, music, and effect objects comprises applying dynamic range compression and leveling. In some embodiments, processing the dialog objects comprises applying dialog enhancement to the dialog objects; processing the music objects comprises applying virtualization and surround enhancement to the music objects; and processing the effect objects comprises applying three-dimensional, virtualization, decorrelation and diffusion effects. In some embodiments, the object-based audio decoder is further configured for decoding height attributes from the input audio stream; and the object post-processor is further configured for applying height virtualization based at least in part on rendering parameters included in the decoded height attributes. In one embodiment, the height attributes are extracted from spatial positions included in the dialog, music, and effect objects. Alternatively, the height attributes are included in height objects from the input audio stream. In some embodiment, the object post-processor is integrated with the object-based audio decoder.

Various exemplary embodiments further relate to a non-transitory computer-readable storage medium storing computer-executable instructions that when executed cause one or more processors to perform operations comprising: receiving an input audio stream comprising encoded dynamic objects including dialog, music, and effect (DME) objects, each dynamic object comprising object attributes including rendering parameters for the corresponding object; decoding from the input audio stream the dynamic objects including dialog, music, and effect objects; processing, in a first separate signal path, the decoded dialog objects based at least in part on the rendering parameters included in the dialog object attributes; processing, in a second separate signal path, the decoded music objects based at least in part on the rendering parameters included in the music object attributes; processing, in a third separate signal path, the decoded effect objects based at least in part on the rendering parameters included in the effect object attributes; and mixing the processed DME objects to produce an output audio signal for individual and customized rendering of the dynamic objects.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating an exemplary object-based audio system, according to one embodiment.

FIG. 2 illustrates an exemplary construction of an object-based audio bitstream, according to one embodiment.

FIG. 3 is a block diagram illustrating an exemplary configuration for post-processing of 7.1-ch DME and 4-ch height objects, according to one embodiment.

FIG. 4 is a block diagram illustrating another exemplary configuration for post-processing of 11.1-ch DME objects, according to one embodiment.

FIG. 5 illustrates yet another example of post-processing configuration with 11.1-ch DME input objects, according to one embodiment.

FIG. 6 is a flowchart illustrating an example process for processing an object-based audio signal, according to one embodiment.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, and the like are used solely to distinguish one from another entity without necessarily requiring or implying any actual such relationship or order between such entities.

The present invention concerns processing audio signals, which is to say signals representing physical sound. These signals are represented by digital electronic signals. In the discussion which follows, analog waveforms may be shown or discussed to illustrate the concepts; however, it should be understood that typical embodiments of the invention will operate in the context of a time series of digital bytes or words, said bytes or words forming a discrete approximation of an analog signal or (ultimately) a physical sound. The discrete, digital signal corresponds to a digital representation of a periodically sampled audio waveform. As is known in the art, for uniform sampling, the waveform must be sampled at a rate at least sufficient to satisfy the Nyquist sampling theorem for the frequencies of interest. For example, in a typical embodiment a uniform sampling rate of approximately 44.1 kHz may be used. Higher sampling rates such as 96 kHz may alternatively be used. The quantization scheme and bit resolution should be chosen to satisfy the requirements of a particular application, according to principles well known in the art. The techniques and apparatus of the invention typically would be applied interdependently in a number of channels. For example, it could be used in the context of a “surround” audio system (having more than two channels).

As used herein, a “digital audio signal” or “audio signal” does not describe a mere mathematical abstraction, but instead denotes information embodied in or carried by a physical medium capable of detection by a machine or apparatus. This term includes recorded or transmitted signals, and should be understood to include conveyance by any form of encoding, including pulse code modulation (PCM), but not limited to PCM. Outputs or inputs, or indeed intermediate audio signals could be encoded or compressed by any of various known methods, including MPEG, ATRAC, AC3, or the proprietary methods of DTS, Inc. as described in U.S. Pat. Nos. 5,974,380; 5,978,762; and 6,487,535. Some modification of the calculations may be required to accommodate that particular compression or encoding method, as will be apparent to those with skill in the art.

The present invention may be implemented in a consumer electronics device, such as a DVD or BD player, TV tuner, CD player, handheld player, Internet audio/video device, a gaming console, a mobile phone, or the like. A consumer electronic device includes a Central Processing Unit (CPU) or a Digital Signal Processor (DSP), which may represent one or more conventional types of such processors, such as an IBM PowerPC, Intel Pentium (x86) processors, and so forth. A Random Access Memory (RAM) temporarily stores results of the data processing operations performed by the CPU or DSP, and is interconnected thereto typically via a dedicated memory channel. The consumer electronic device may also include storage devices such as a hard drive, which are also in communication with the CPU or DSP over an I/O bus. Other types of storage devices such as tape-drives, optical disk drives may also be connected. A graphics card is also connected to the CPU or DSP via a video bus, and transmits signals representative of display data to the display monitor. External peripheral data input devices, such as a keyboard or a mouse, may be connected to the audio reproduction system over a USB port. A USB controller translates data and instructions to and from the CPU for external peripherals connected to the USB port. Additional devices such as printers, microphones, speakers, and the like may be connected to the consumer electronic device.

The consumer electronic device may utilize an operating system having a graphical user interface (GUI), such as WINDOWS from Microsoft Corporation of Redmond, Wash., MAC OS from Apple, Inc. of Cupertino, Calif., various versions of mobile GUIs designed for mobile operating systems such as Android, and so forth. The consumer electronic device may execute one or more computer programs. Generally, the operating system and computer programs are tangibly embodied in a computer-readable medium, e.g., one or more of the fixed and/or removable data storage devices including the hard drive. Both the operating system and the computer programs may be loaded from the aforementioned data storage devices into the RAM for execution by the CPU or DSP. The computer programs may comprise instructions which, when read and executed by the CPU or DSP, cause the same to perform the steps to execute the steps or features of the present invention.

The present invention may have many different configurations and architectures. Any such configuration or architecture may be readily substituted without departing from the scope of the present invention. A person having ordinary skill in the art will recognize the above described sequences are the most commonly utilized in computer-readable mediums, but there are other existing sequences that may be substituted without departing from the scope of the present invention.

Elements of one embodiment of the present invention may be implemented by hardware, firmware, software or any combination thereof. When implemented as hardware, an embodiment of the present invention may be employed on one audio signal processor or distributed amongst various processing components. When implemented in software, the elements of an embodiment of the present invention are essentially the code segments to perform the necessary tasks. The software preferably includes the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information.

Examples of the processor readable medium include an electronic circuit, a semiconductor memory device, a read only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operation described in the following. The term “data” here refers to any type of information that is encoded for machine-readable purposes. Therefore, it may include program, code, data, file, etc.

All or part of an embodiment of the invention may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

One embodiment of the invention may be described as a process which is usually depicted as a flowchart, a flow diagram, a structure diagram, or a block diagram. Although a block diagram may describe the operations as a sequential process, many of the operations can be performed in parallel or concurrently. In addition, the order of the operations may be re-arranged. A process is terminated when its operations are completed. A process may correspond to a method, a program, a procedure, etc.

### Overview

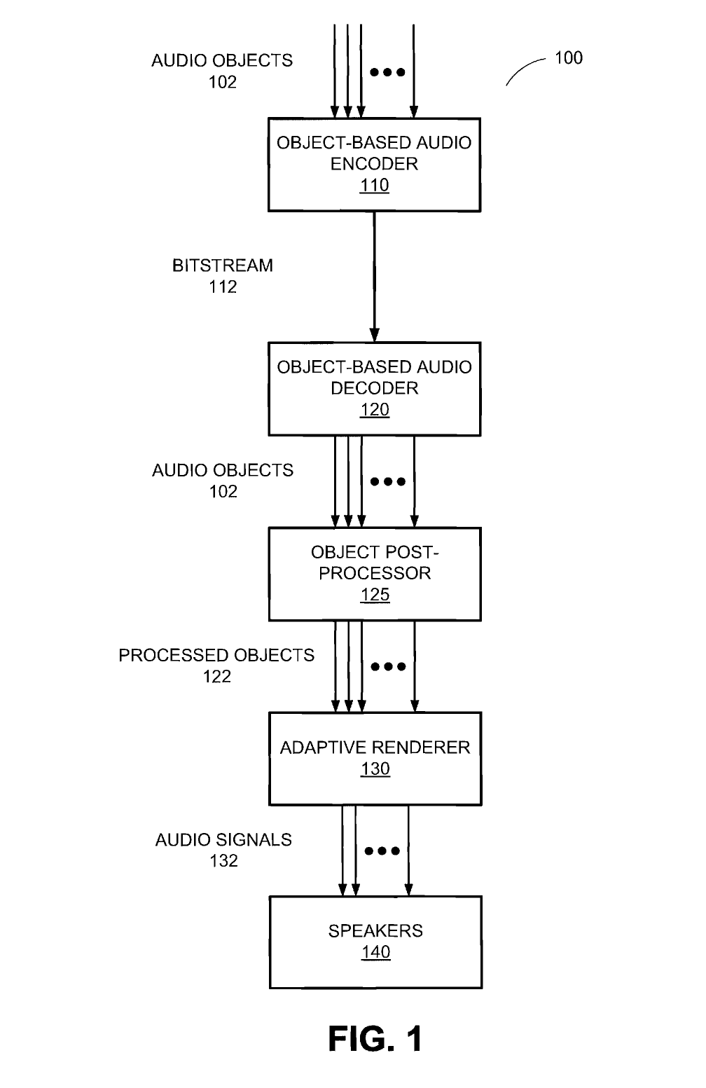

FIG. 1 is a block diagram illustrating an exemplary object-based audio system 100, according to one embodiment. System 100 includes an object-based audio encoder 110, an object-based audio decoder 120, an object post-processor 125, an adaptive renderer 130, and one or more speakers 140. Audio objects are provided to the object-based audio system 100, which generates an object-based audio stream that can be decoded, processed, rendered, and output to one or more speakers.

In some embodiments, the object-based audio encoder 110 functions as an audio object creation system for content creators. Audio objects can be generated from any type of audio by associating audio data with its attributes. Audio data can be recorded or otherwise obtained. A user interface may be provided by the object-based audio encoder 110 for a content creator to access, edit, or otherwise manipulate the audio data. The audio data represents any audio clip given forth by a sound source or a collection of sound sources, such as dialog, music, or ambient sound.

Sound sources often have one or more attributes that the object-based audio encoder 110 can associate with the audio data to create an object. Examples of attributes include a location of the sound source, a velocity of a sound source, directivity of a sound source, and so on. Some attributes may be obtained directly from the audio data, such as a timestamp denoting the time of recording. Other attributes can be supplied by the content creator to the object-based audio encoder 110, such as the type of sound source, e.g., a car versus an airplane. Still other attributes can be automatically imported by the object-based audio encoder 110 from other devices. For example, the location of a sound source can be retrieved and imported from a Global Positioning System (GPS) device. The object-based audio encoder 110 may store the audio objects 102 in an audio data repository, such as a local database or cloud-based data storage.

The object-based audio encoder 110 can also encode and/or compress the audio objects 102 into a bitstream 112. The object-based audio encoder 110 may use any codec or compression technique to encode the audio objects. In one embodiment, audio objects 102 are encoded as uncompressed pulse code modulated (PCM) audio together with associated attributes. In another embodiment, the object-based audio encoder 110 applies compression to the objects using one of the Moving Picture Experts Group (MPEG) standards, e.g., the MP3 format.

The object-based audio encoder 110 can encode one or more audio objects into an audio stream suitable for transmission over a content distribution network (CDN), which includes LAN, WAN, the Internet, or combinations of the same. Alternatively, the object-based bitstream 112 can be stored on a computer-readable storage medium, such as a DVD or Blue-ray Disk. A media player, such as a Blue-ray player, can play back the object-based audio stream stored on the disk. An object-based audio package can also be downloaded to a user system and then played back from the local storage.

In some embodiments, the bitstream 112 generated by the object-based audio encoder 110 is composed of frames, each including one or more audio objects. An audio object comprises an audio payload with a header of object-specific metadata that describes certain attributes or characteristics of the payload. Some audio objects may include metadata only and no audio payload, while other audio objects include an audio payload but little or no metadata. The attributes or characteristics of an audio object may include positional location in three-dimensional (3D) space at a given time, measured loudness values, the nature of the object (such as an instrument, effect, music, background, or dialog), dialog language, how to display the object, and metadata in the form of instructions on how to process, to render, or to playback the object.

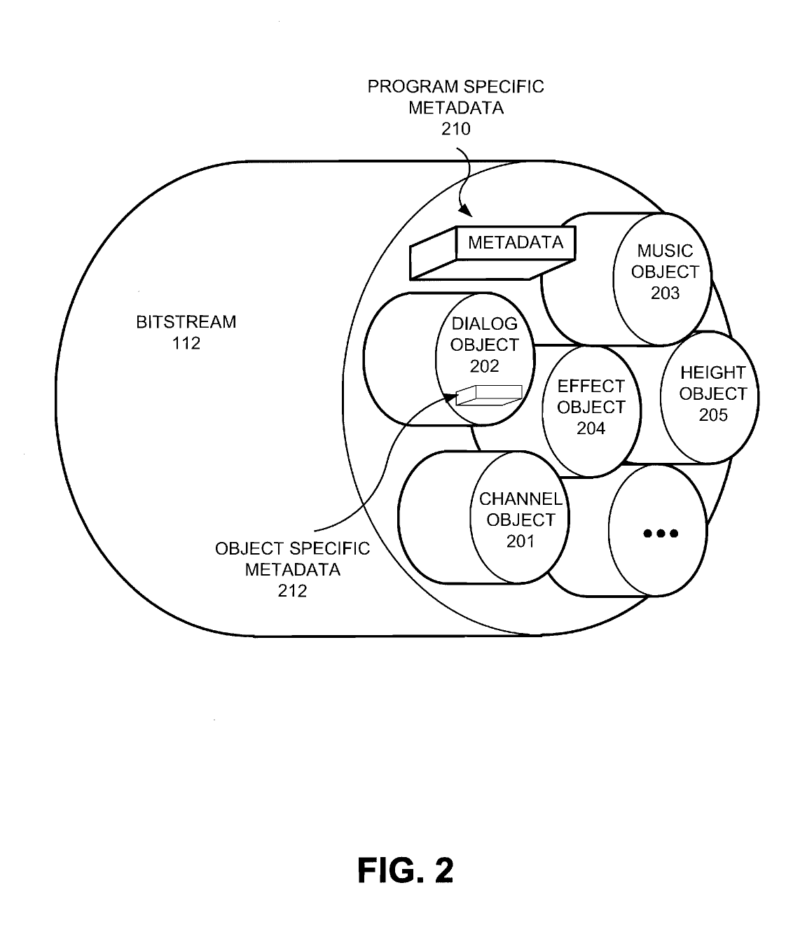

FIG. 2 illustrates an exemplary construction of an object-based audio bitstream 112, according to one embodiment. Examples of the object-based audio bitstream include the multi-dimensional audio (MDA) broadcast bitstream and DTS:X bitstream. The bitstream 112 includes program specific metadata 210 and a plurality of audio objects 201-205. MDA is an open format that includes a bitstream representation and an object-based audio (OBA) payload. MDA is a completely open object-based immersive audio platform that allows any content provider to mix object-based audio or any combination of object-based audio and channel-based audio. For example, the content can be mixed using twelve speakers and MDA will map the content to any playback configuration, such as 5.1ch or stereo.

There are two different types of objects shown in FIG. 2, namely static channel object (beds) 201 and dynamic objects 202-205. Static channel object 201 represents multi-channel audio, such as 5.1ch or 7.1ch surround sound. Each channel can be represented as a static object 201. Some content creators use channels instead of or in addition to the object-based audio systems to facilitate backwards compatibility with existing fixed-channel systems and to promote ease of transition.

Dynamic objects 202-205 include any objects that can be used instead of or in addition to the static channel object 201. Dynamic objects provide enhancements that, when rendered together with static channel objects, enhance the audio associated with the traditional surround sound. For example, dynamic objects may include psychoacoustic information that a renderer can use to enhance the static channel objects. Dynamic objects can also include background audio objects (e.g., a passing airplane) for a renderer to enhance an audio scene. However, dynamic audio objects are not limited to just enhancement objects, but also include dialog object 202, music object 203, effect object 204, and height object 205, among other types of dynamic objects, as shown in FIG. 2. Depending on the types of the dynamic objects, audio objects in the audio stream 112 can be grouped into different object groups, such as dialog object group that includes all the dialog objects, music objects group that includes all the music objects, effect object group that includes all the effect objects, height object group that includes all the height objects, and so on.

Metadata associated with static objects, such as the channel object 201, can be little or nonexistent. In one embodiment, channel object metadata simply indicates to which channel the static channel objects correspond. Since this metadata does not change, the static objects are therefore static in their object attributes. In contrast, dynamic objects, such as audio objects 202-205, include dynamic object attributes, such as changing position, velocity, and so forth. Some dynamic objects may contain little or no audio payload. Effect object 204, for example, may include information on the desired characteristics of the acoustic environment in which a scene takes place. The metadata of the effect object 204 can specify the type of building or outdoor area, such as a room, office, cathedral, stadium, or the like. A renderer can use this information to adjust playback of the audio in the static channel object 201, for example, by applying an appropriate amount of reverberation or delay corresponding to the indicated environment.

Content creators can declare static objects or dynamic objects using a descriptive computer language when creating the bitstream (e.g., using object-based audio encoder 110 in FIG. 1). In some cases, a content creator can request that one or more static audio objects (e.g., a center dialog channel) be always on. On the other hand, dynamic audio objects may be added and removed and not always be present in the audio stream. In other cases, it may be desirable to gate or otherwise toggle static objects. For instance, when dialog is not present in a given static object, not including the static object in the bitstream can save computing and network resources. Examples of object-based audio system for streaming are described in more details in U.S. application Ser. No. 12/856,442, filed Aug. 13, 2010, titled “Object-Oriented Audio Streaming System,” which is hereby incorporated by reference in its entirety.

Referring back to FIG. 1, the bitstream 112 carrying metadata headers and audio payloads for different audio objects is inputted to the object-based audio decoder 120. The bitstream 112 can be transmitted over a content-distribution network or delivered through a computer-readable storage medium. The object-based audio decoder 120 implemented on a user system can receive and decode the bitstream 112 into its constituent audio objects 102. Next, each of the decoded audio objects 102 can be processed by the object post-processor 125. The purpose and functionality of the object post-processor 125 are described in more details in the section below. The object post-processor 125 then provides the processed audio objects 122 to the adaptive renderer 130. In some embodiments, the object post-processor 125 and the audio object renderer 130 can be directly implemented and integrated into the object-based audio decoder 120. In pure OBA, the processed objects 122 are not mapped to a specific channel. In fact, it may be unknown how many channels the playback configuration contains. In other words, the audio object 122 is intended to be processed in a unitary fashion independent of any particular pre-defined or fixed playback configuration of rendering speakers. In these situations, the rendering process is done later so as to convert and to mix the playback channels (as defined by the playback configuration).

The adaptive renderer 130 can render the audio objects into audio signals 132 suitable for playback on one or more speakers 140. The adaptive renderer 130 may include a variety of different rendering features, audio enhancements, psychoacoustic enhancements, and the like for rending the audio objects. In some embodiments, the adaptive renderer 130 can advantageously use the object attributes of the audio objects as cues on how to render the audio objects. For example, the adaptive renderer 130 can use a position attribute of an audio object to pan the audio from one speaker to another. As another example, the adaptive renderer 130 may use the same position attribute to perform 3D psychoacoustic filtering to the audio object in response to determining that a psychoacoustic enhancement is available to the audio object renderer 130. In general, the audio object renderer 130 can take into account some or all resources available to create the best possible presentation. As rendering technology improves, additional rendering features or rendering resources can also be added to the audio object renderer 130 that take advantage of the format or construction of the audio objects. Examples of object-based audio encoder and decoder and rendering of the audio objects are described in more details in U.S. application Ser. No. 13/415,667, filed Mar. 8, 2012, titled “System for Dynamically Creating and Rendering Audio Objects,” which is hereby incorporated by reference in its entirety.

### DME and Height Post-Processing

It is known to algorithm developers that post-processing on mixed audio signals can introduce problems like degradation on dialog quality or dynamic range, and phase cancelation in music. There has been work focused on blind source separation approaches in processing mixed audio signals. However, it is very hard, if not possible, to achieve perfect source separation for different audio contents. The resulting audio quality from blind source separation is therefore not optimal. Moreover, audio coding and post-processing are generally considered to be in different categories of audio processing. Object-based audio coding is not specifically designed for post-processing of audio signals, and existing post-processing approaches assumedly do not take advantage of object-based audio coding either.

On the other hand, object-based soundfield representation and encoding can offer many advantages over the commonly used speaker-based or channel-based representation. For instance, object-based audio coding can preserve more of the information created on the soundstage, including positional information, and hence more of the creative intent. In fact, object-based audio coding can make translating a soundfield to different loudspeaker configurations more predictable. The improved discreteness of the delivered sounds may also allow possible post-processing to be applied to the selected sound elements without unintentionally affecting other sounds.

Embodiments of the present disclosure provide an object-based audio post-processing method and system that applies different or customized audio post-processing to different individual audio objects or object groups, such as dialog, music, effects (DME), and height objects, instead of just using object-based audio for encoding. Applying different post-processing to DME and height objects has many benefits over processing a mixed signal, especially when the number of output channels is smaller than the number of input channels (although it can be applied to any combination of input and output channels). For example, improved post-processing can be achieved in producing more immersive surround and 3D effects, better dialog clarity and leveling, and more pronounced rendering for each object or object group. In addition, DME and height post-processing is not limited to any particular number of output channels. It can be applied to different output channel configurations, e.g., 2-ch, 3.1-ch, 5.1-ch, 7.1-ch, or 11.2-ch, etc.

DME and height post-processing not only overcomes the abovementioned problems introduced by post-processing on mixed audio signals, but also helps render the object-coded audio in a more flexible and efficient way within reproduction devices. The post-processor (e.g., the object post-processor 125 in FIG. 1) for DME and height objects may be employed either before the encoder pre-mixes the audio objects in production or after the object-based decoder outputs the audio objects from the audio stream. In other words, the post-processor is independent from object-based audio coding—it needs not to know when the objects are rendered and may take as input audio objects pre-rendered before encoding or rendered after decoding. For example, in FIG. 1, the object post-processor 125 receives the audio objects 102 decoded by the object-based audio decoder 120 and outputs the processed objects 122 to the adaptive renderer 130.

Although DME and height post-processing is independent of renderer in functionality, the post-processor can be integrated with an object decoder and/or audio renderer in general. In fact, the decoding and playback system can be designed more efficiently based on how the objects are rendered. If audio objects are rendered in the decoding stage, applying object processing right before rendering can save a lot of system resources. For example, having 2-ch audio dynamics processing before rendered to 11.1-ch is more efficient than performing 11.1-ch dynamics processing. Fewer resources are needed to align DME and height post-processing with the output channel configurations than object processing plus virtualized down-mixing by the renderer.

Examples of post-processing of different audio objects (e.g., dialog, music, effect, and height) include, but not limited to, dynamic range compression and leveling, virtual surround and/or surround enhancement for dialog and/or music, 3D audio and/or diffused sound effect, virtualization of height channel, among many other audio processing methods. Examples of dynamic range compression and leveling are described in more details in U.S. application Ser. No. 12/901,330, filed on Oct. 8, 2010, titled “Adaptive Dynamic Range Enhancement of Audio Recordings,” examples of immersive audio rendering are described in more details in U.S. application Ser. No. 13/342,743, filed Jan. 3, 2012, titled “Immersive Audio Rendering System,” and examples of 3D audio rendering are described in more details in U.S. application Ser. No. 14/026,984, filed Mar. 15, 2012, titled “Encoding and Reproduction of Three Dimensional Audio Soundtracks,” which are hereby incorporated by reference in their entireties.

In some embodiments, the object-based audio encoder 110 renders all objects and channel-based audio (beds) to a reference format and calculates a full program integrated loudness measure to store as metadata. The metadata allows the post-processor 125 to provide controls over the output levels or amplitudes of different audio objects. For example, the post-processor 125 may include loudness control or leveling modules that control the time-varying gains of one or more of the audio objects such that the average loudness level of the output signal can be normalized to the predetermined target loudness level specified by the metadata. As another example, dialog is usually considered the most important audio element in a movie or television program. It has been shown that the preferred ratio of dialog level to non-dialog level varies significantly from person to person and from one age group to another. Therefore, the post-processor 125 can increase the gain of dialog objects or suppress the ambient sound (e.g., background music or noise) level so that dialog is more prominent. The dialog object can be generally enhanced based on its type as dialog object specified in the object metadata. In addition, the post-processor 125 may further adjust the levels of the dialog enhancement based on customizable settings from users. This dialog enhancement technique helps increase the ratio of dialog to non-dialog loudness level, which can benefit the elderly, hearing-impaired, or other listeners when they are enjoying television, home theater movies, or other audio video programs.

Furthermore, dynamic range compression (DRC) can be applied to the dialog and/or music objects. DRC assumes that the long-term average level of a signal is already normalized to an expected level and attempts to modify only the short-term dynamics. A dynamic range control module included in the post-processor 125 may compress the dynamics so that loud events are attenuated and quiet events are amplified. For instance, many portable playback devices cannot decode and playback the encoded audio content having wide bandwidth and wide dynamic range with consistent loudness and intelligibility. This problem can be overcome by including in the audio objects suitable dynamic range compression profiles. The post-processor 125 can then extract from the DRC profiles either absolute values or differential values relative to another known compression profile and adaptively apply gains for limiting the playback by the portable devices.

Unlike dialog and music objects, effect objects may contain little or no audio payload, but can specify, for example, the desired characteristics of the acoustic environment in which a scene takes place. These effect objects 204 include metadata on the type of building or outdoor area where the audio scene occurs, such as a room, office, alley, parking garage, cathedral, concert hall, stadium, arena, cave, mountains, underwater, or the like. The post-processor can use this information to adjust playback of the audio in the objects, for example, by applying an appropriate amount of reverberation or delay corresponding to the indicated environment. In some embodiments, the effect objects contain more attributes than merely the acoustic environment presets listed above. For example, a customized environment can be described with one or more specific attributes, such as an amount of reverberation (that needs not be a preset), an amount of echo, a degree of background noise, among many other possible configurations. Similarly, attributes of audio objects can generally have forms other than values. For example, an attribute can be a snippet of code or instructions that define a behavior or characteristic of a sound source.

A significant advantage of DME and height post-processing is that the post-processor can implement the most accurate spatial audio synthesis technique available to render each audio object in any target spatial audio format selected at the reproduction end. In one embodiment, the height objects include the perceived spatial position of each audio object, either absolute or relative to the virtual position and orientation of the listener in the audio scene. Alternatively, the height information (as part of the spatial positions) can be included in and extracted from the metadata of an audio object, such as a dialog, music, or effect object. The position information in the object metadata may be in the format of coordinates in three-dimensional space, such as x, y, z coordinates, spherical coordinates, or the like. The post-processor can determine filter parameters that create changing phase and gain relationships based on positions of objects, as reflected in the object metadata, either directly from height objects or extracted from other dynamic objects. As an example, as the depth of an object with respect to a listener is explicitly encoded in the audio objects, the post-processor 125 in FIG. 1 can generate appropriate depth-rendering filter parameters (e.g., coefficients and/or delays) based on the object position information. The adaptive renderer 130 can then proceed to perform dynamic decorrelation based on the calculated filter parameters.

Conventional 5.1-ch or 7.1-ch systems have the limitation that all loudspeakers are located in the horizontal plane, thus sound with height information can be hard to reproduce. To create immersive 3D audio experience, new-generation surround sound systems have added multiple height loudspeakers for rendering elevated channels or sound objects. More often though, consumers may shun from installing height speakers at home due to practical reasons, such as space, cost and complexity. Hence, it is very desirable for an object-based post-processor to produce virtual sound elevation through any conventional multichannel surround system, stereo, or even headphones. Rather than virtualizing individual objects to multiple speaker locations, the post-processor using separate height processing based on height objects also gives big resource savings which can be critical for CE devices.

One way to generate virtual sound elevation at desired height is by measuring individual listeners Head-Related Transfer Functions (HRTFs) at various three dimensional (3D) positions and then filtering the input audio signals with an HRTF. Virtually elevated sound images can also be generated using non-individualized spectral cues, which are then applied to the audio signals. A generalized or non-individualized HRTF may be calculated by averaging and/or clustering multiple HRTFs, such as those from the CIPIC HRTF database.

Another advantage of object-based post-processing is that it allows for interactive modifications of the reproduced audio scene, including remixing, music re-interpretation (e.g. karaoke), or virtual navigation in the scene (e.g. gaming). This is achieved by controlling the post-processing according to user input, user preferences, and/or user interaction configurations at the post-processor 125. For example, a selected object can be removed from the audio objects 102 and the corresponding object audio signal is replaced by a different audio signal received separately and provided to the adaptive renderer 130 based on user language settings or user input. This is advantageous in applications such as multi-lingual movie soundtrack reproduction or karaoke and other forms of audio re-interpretation. In addition, audio objects not included in the bitstream 112, such as augmented environmental sound, may be provided separately to the adaptive renderer 130 in interactive gaming applications.

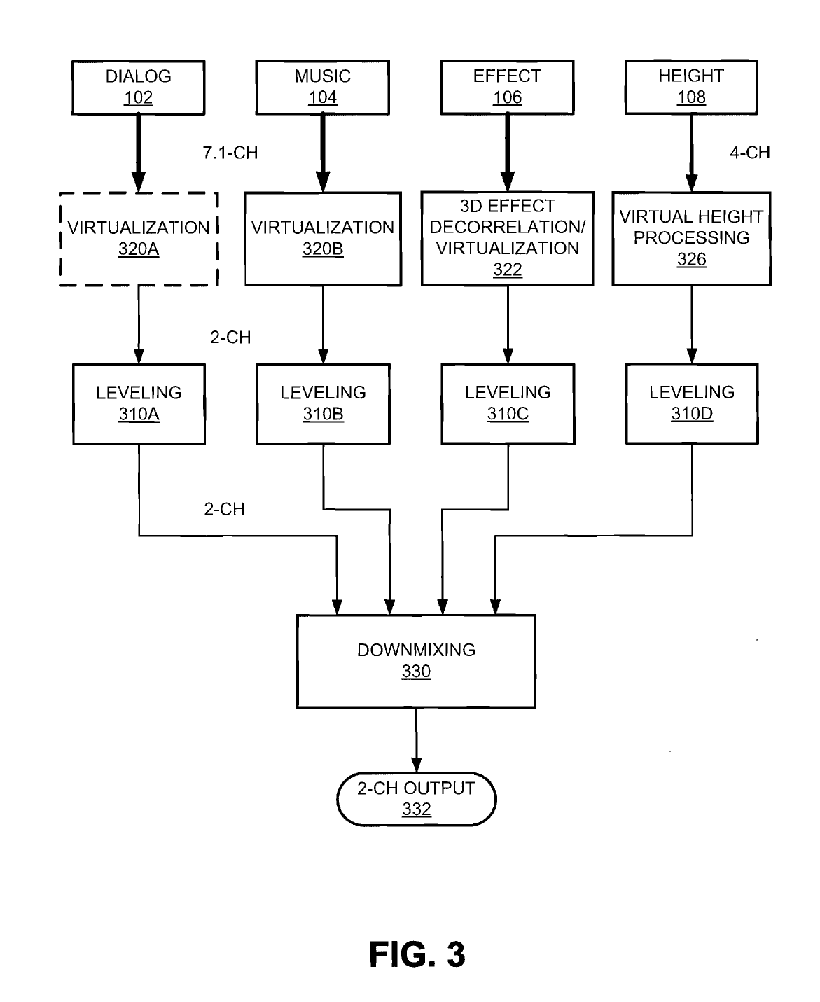

FIGS. 3-5 each illustrates an example of various configurations for DME and height post-processing and audio rendering. The post-process applied to each of DME and height objects is different and the numbers of the output channels differ in these example configurations. However, they all share a common feature where each of the dialog, music, effect, and height objects is processed independently in a separate signal path.

FIG. 3 is a block diagram illustrating an exemplary configuration for post-processing of 7.1-ch DME and 4-ch height objects, according to one embodiment. The post-processing configuration in FIG. 3 comprises a virtualization module 320A for dialog objects 102, a virtualization module 320B for music objects 104 in a separate signal path, a 3D effect decorrelation/virtualization module 322 for effect objects 106 in another separate signal path, a virtual height processing module 326 for height objects 108 in yet another separate signal path, four leveling modules 310A-310D, and a downmixing module 330. In this configuration, the four height channels 108 come separately as input objects, hence extraction of the height information from other audio objects or channels is not necessary. There is no DRC applied to the DME and height objects because the height objects include part of the DME content and applying DRC in this processing chain would change the overall sound balance. The leveling by modules 310A-310D at the end of the processing chain is used for interactive volume control; users can specify volume preference for each object or object group or select object isolation (ex. Karaoke). The processed audio objects are down-mixed to generate a 2-ch output 332.

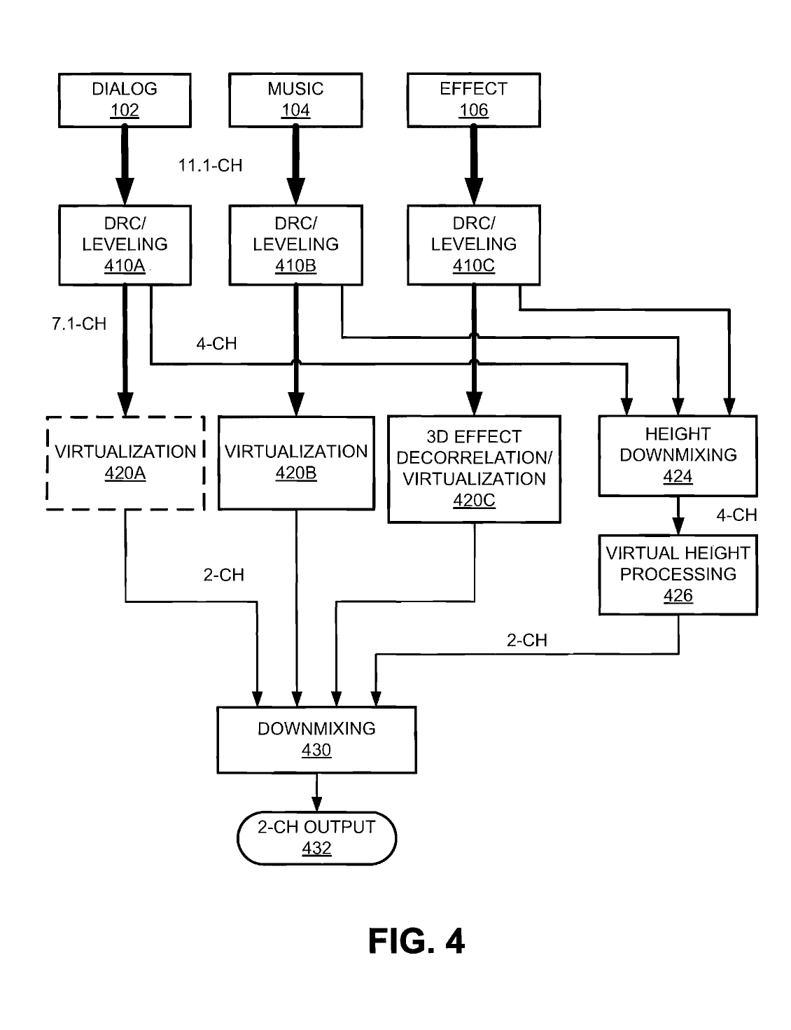

FIG. 4 is a block diagram illustrating another exemplary configuration for post-processing of 11.1-ch DME objects with 2-ch output. This configuration includes 11.1-ch DME object input, DRC/leveling modules 410A, 410B, and 410C in separate signal paths for dialog objects 102, music objects 104, and effect objects 106, respectively. Four-channel height objects are extracted from the 11.1-ch DME objects after dynamics processing by the DRC/leveling modules 410A-410C. The rest of the 7.1-ch DME objects are then processed by the virtualization modules 420A-420C, respectively. The virtualization module 420C may also apply 3D effect decorrelation based on the effect objects. Furthermore, each virtualization module can contain downmix capability for different output channel configurations. As described earlier, the DME objects are processed separately in order to preserve characteristics of each object or object group and to produce better effect quality. After individual processing, the DME and height channels are downmixed to the number of channels of given devices, in this example, a 2-ch output 432.

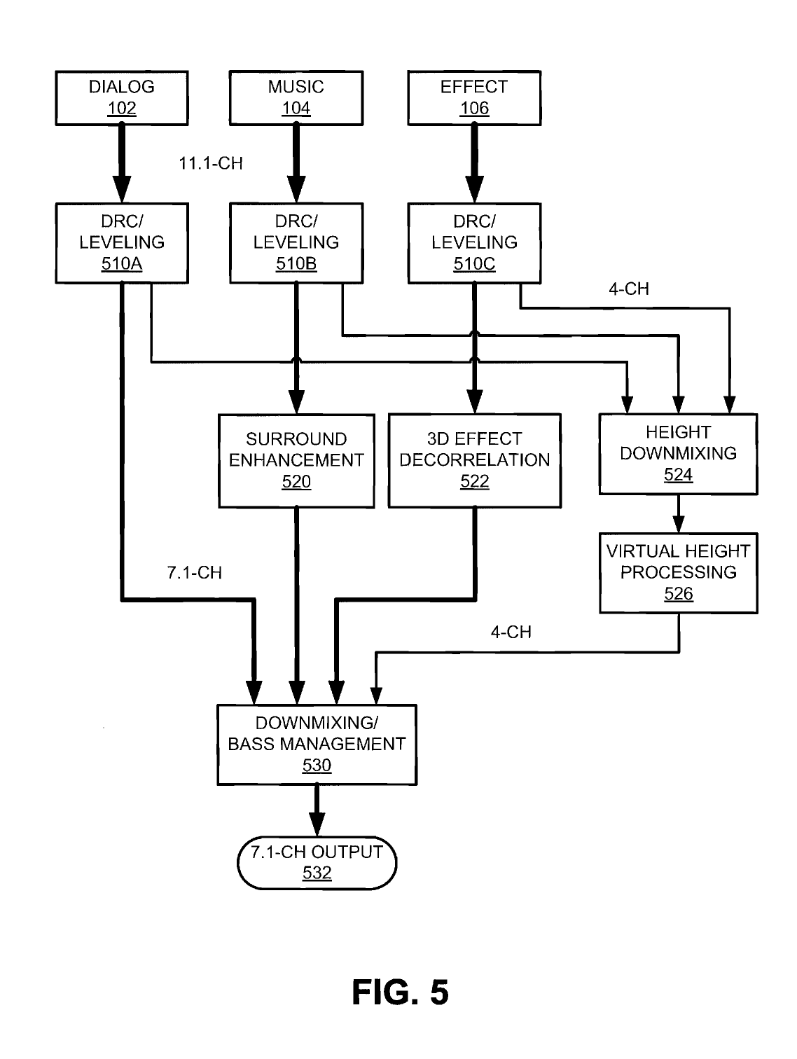

FIG. 5 illustrates yet another example of post-processing configuration with 11.1-ch DME input objects, but with a multi-channel output (7.1-ch). Similar to the example configuration shown in FIG. 4, four height channels are extracted from the 11.1-ch input DME objects after dynamics processing. The configuration comprises an 11.1-ch DME object input, DRC/leveling modules 510A, 510B, and 510C in separate signal paths for dialog objects 102, music objects 104, and effect objects 106, respectively. Since it is designed with a 7.1-ch output setup, virtualization in a horizontal plane would not be required. Instead, music objects are processed by a surround enhancement module 520, while effect objects go through a 3D effect decorrelation module 522 to generate an immersive 3D sound field. The height channels are now down-mixed by a height downmixing module 524 and then virtualized by a virtual height processing module 526 to 4 channels. Afterwards, the processed signals are input to a downmixing/bass management module 530 to produce a 7.1-ch output 532.

The best way for implementing the DME and height post-processor is to integrate it with the object decoder because in most cases, both of the decoding and post-processing are performed by devices in the reproduction stage. Depending on the configuration of the post-processor, particularly the number of inputs and outputs, this integration can save system resources through efficient system architecting. For example, dynamics processing before rendering can reduce the number of channels that need to be processed, and applying some of the virtualization during rendering may bring additional resource savings. Furthermore, the location and design of the renderer can also give some benefits to overall systems. If height objects are extracted in the decoding stage as shown in FIG. 4, the reproduction system saves resources on rendering. Hence, it is desirable to combine the post-processing suite with the object decoder in a full package for various consumer electronics products, such as TV, home AV, soundbar, PC, and mobile devices.

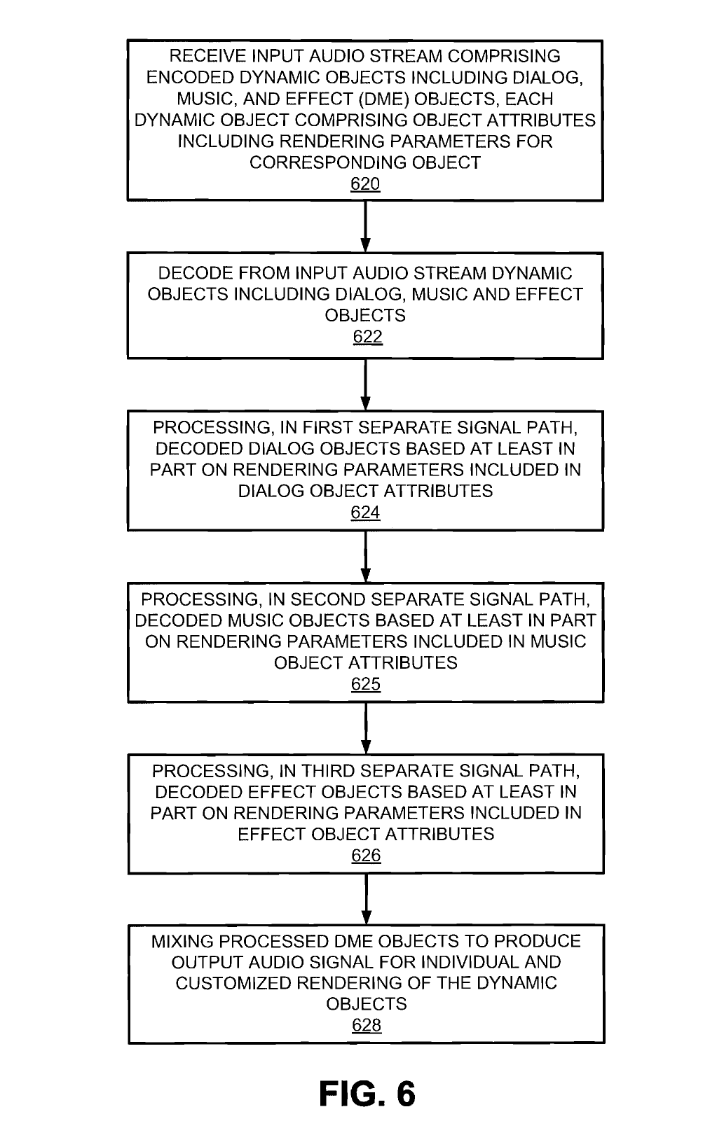

FIG. 6 is a flowchart illustrating an example process for processing an object-based audio signal, according to one embodiment. It should be noted that FIG. 6 only demonstrates one of many ways in which the embodiments of the object-based audio processing may be implemented. The method for providing the object-based audio processing involves, for example, the object-based audio decoder 120, the object post-processor 125, and the adaptive renderer 130, as shown in FIG. 1. The process begins with the object-based audio decoder 120 receiving (step 620) an object-based audio stream (e.g., bitstream 112) as an input. The input stream can be transmitted over a content-distribution network or delivered through a computer-readable storage medium. The input audio stream comprises dynamic objects as well as static channel objects (beds). Dynamic objects, such as dialog object, music object, effect object, and height object, may include audio payload as well as dynamic object attributes (metadata) including rendering parameters for the corresponding dynamic objects, such as sound source position, velocity, and so forth.

Next, the object-based audio decoder 120 decodes and extracts (step 622) from the audio stream the static channel objects as well as the dynamic objects, including dialog objects, music objects, effect objects, and/or height objects (or attributes). Each of the decoded and extracted objects or object groups is then passed to the object post-processor 125 to be processed separately.

In a first separate signal path, the decoded dialog objects are processed (step 624) based at least in part on the rendering parameters included in the dialog object attributes and/or user interaction configurations. The object post-processor 125 can process (step 625), in a second signal path, the decoded music objects based at least in part on the rendering parameters included in the music object attributes and/or user interaction configurations. In a third signal path, the object post-processor 125 processes (step 626) the decoded effect objects based at least in part on the rendering parameters included in the effect object attributes and/or user interaction configurations. For example, dynamic range compression and leveling can be applied to dialog and music objects for controlling or normalizing short-term and long-term volume and pressure level of the sound. Other post-processing specified by the effect objects can also be applied to the music or dialog objects, including three dimensional, virtual surround and surround enhancement. These effects may be specified in the effect objects with acoustic environment presets, or described using more specific effect attributes, such as the amount of reverberation, parameters for decorrelation filters, and diffusion settings, among many other possible configurations.

In addition, the post-processor 125 can provide virtualization of height objects by producing virtual sound elevation through conventional multichannel surround systems, stereo, or even headphones. Note that during this post-processing of the DME objects, the height objects may be extracted from the separately processed dialog, music, and effect objects or object groups. Alternatively, the height objects are included in and extracted directly from the received object-based audio stream. After the dynamic objects are processed separately, the adaptive renderer 130 can mix (step 628) the processed DME objects as well as the height objects into output audio signals 132 suitable for playback on audio playback devices, such as speakers 140.

In conclusion, the method and apparatus disclosed in the embodiments deliver object-dependent post-processing for each individual object or object group in an object-based audio signal. Applying separate post-processing to the dialog, music, effect and/or objects or object groups in different signal paths allows customized and interactive control of each of the objects or object groups based in part on object attributes and/or user interaction configurations, so as to achieve improved post-processing by producing more immersive surround and 3D effects, better dialog clarity and leveling, and more pronounced or selectable rendering for each object or object group. The post-processor is independent from object-based audio coding thus can be employed either before the object pre-mix in production or after the object decoding.

The particulars shown herein are by way of example and for purposes of illustrative discussion of the embodiments of the present invention only, and are presented in the case of providing what is believed to be the most useful and readily understood description of the principles and conceptual aspects of the present invention. In this regard, no attempt is made to show particulars of the present invention in more detail than necessary for the fundamental understanding of the present invention, the description taken with the drawings make apparent to those skilled in the art how the several forms of the present invention may be embodied in practice.

What is claimed is:

1. A method for processing an object-based audio signal, comprising:
receiving an input audio stream comprising encoded dynamic objects including dialog, music, and effect (DME) objects, each dynamic object comprising object attributes including rendering parameters for the corresponding object;
decoding from the input audio stream the dynamic objects including dialog, music, and effect objects;
processing, in a first separate signal path, the decoded dialog objects based at least in part on the rendering parameters included in the dialog object attributes;
processing, in a second separate signal path, the decoded music objects based at least in part on the rendering parameters included in the music object attributes;
processing, in a third separate signal path, the decoded effect objects based at least in part on the rendering parameters included in the effect object attributes; and
mixing the processed DME objects to produce an output audio signal for individual and customized rendering of the dynamic objects.

2. The method of claim 1, wherein processing separately the decoded dialog, music, and effect objects is based in part on user interaction configurations.

3. The method of claim 1, wherein processing separately the decoded dialog, music, and effect objects comprises applying dynamic range compression and leveling.

4. The method of claim 1, wherein processing the dialog objects comprises applying dialog enhancement to the dialog objects.

5. The method of claim 1, wherein processing the music objects comprises applying virtualization and surround enhancement to the music objects.

6. The method of claim 1, wherein processing the effect objects comprises applying three-dimensional, virtualization, decorrelation and diffusion effects.

7. The method of claim 1, further comprising:
decoding height attributes from the input audio stream; and
applying height virtualization based at least in part on rendering parameters included in the decoded height attributes.

8. The method of claim 7, wherein the height attributes are extracted from spatial positions included in the dialog, music, and effect objects.

9. The method of claim 7, wherein the height attributes are included in height objects from the input audio stream.

10. An audio apparatus for processing an object-based audio signal, comprising:
an object-based audio decoder configured for:
receiving an input audio stream comprising encoded dynamic objects including dialog, music, and effect (DME) objects, each dynamic object comprising object attributes including rendering parameters for the corresponding object; and
decoding from the input audio stream the dynamic objects including dialog, music, and effect objects;
an object post-processor configured for:
processing, in a first separate signal path, the decoded dialog objects based at least in part on the rendering parameters included in the dialog object attributes;
processing, in a second separate signal path, the decoded music objects based at least in part on the rendering parameters included in the music object attributes; and
processing, in a third separate signal path, the decoded effect objects based at least in part on the rendering parameters included in the effect object attributes; and
a mixer configured for:
mixing the processed DME objects to produce an output audio signal for individual and customized rendering of the dynamic objects.

11. The audio apparatus of claim 10, wherein processing separately the decoded dialog, music, and effect objects is based in part on user interaction configurations.

12. The audio apparatus of claim 10, wherein processing separately the decoded dialog, music, and effect objects comprises applying dynamic range compression and leveling.

13. The audio apparatus of claim 10, wherein processing the dialog objects comprises applying dialog enhancement to the dialog objects.

14. The audio apparatus of claim 10, wherein processing the music objects comprises applying virtualization and surround enhancement to the music objects.

15. The audio apparatus of claim 10, wherein processing the effect objects comprises applying three-dimensional, virtualization, decorrelation and diffusion effects.

16. The audio apparatus of claim 10, wherein the object-based audio decoder is further configured for decoding height attributes from the input audio stream; and the object post-processor is further configured for applying height virtualization based at least in part on rendering parameters included in the decoded height attributes.

17. The audio apparatus of claim 16, wherein the height attributes are extracted from spatial positions included in the dialog, music, and effect objects.

18. The audio apparatus of claim 16, wherein the height attributes are included in height objects from the input audio stream.

19. The audio apparatus of claim 10, wherein the object post-processor is integrated with the object-based audio decoder.

20. A non-transitory computer-readable storage medium storing computer-executable instructions that when executed cause one or more processors to perform operations comprising:
receiving an input audio stream comprising encoded dynamic objects including dialog, music, and effect (DME) objects, each dynamic object comprising object attributes including rendering parameters for the corresponding object;
decoding from the input audio stream the dynamic objects including dialog, music, and effect objects;
processing, in a first separate signal path, the decoded dialog objects based at least in part on the rendering parameters included in the dialog object attributes;
processing, in a second separate signal path, the decoded music objects based at least in part on the rendering parameters included in the music object attributes;
processing, in a third separate signal path, the decoded effect objects based at least in part on the rendering parameters included in the effect object attributes; and
mixing the processed DME objects to produce an output audio signal for individual and customized rendering of the dynamic objects.
